(19) United States
(12) Patent Application Publication
(10) Pub. No.: US 2018/0005111 A1
(43) Pub. Date: Jan. 4, 2018

(54) Generalized Sigmoids and Activation Function Learning

(71) Applicant: International Business Machines Corporation, Armonk, NY (US)

(72) Inventors: Upendra V. Chaudhari, Briarcliff Manor, NY (US); Michael A. Picheny, White Plains, NY (US)

(21) Appl. No.: 15/198,222

(22) Filed: Jun. 30, 2016

(51) Int. Cl. G06N 3/08; G06N 3/04

(52) U.S. Cl. CPC G06N 3/08; G06N 3/04

(57) ABSTRACT

Disclosed herein are systems, methods, and computer-readable media for classifying a set of inputs via a supervised classifier model that utilizes a novel activation function that provides the capability to learn a scale parameter in addition to a bias parameter and other weight parameters.

### BACKGROUND

Machine learning involves the generation and use of algorithms capable of learning from and making predictions on data. Such algorithms typically operate by building a model from example inputs in order to make data-driven predictions or decisions. A number of machine learning approaches have been developed. One such approach, known as an artificial neural network (ANN) or simply a neural network (NN), is a learning algorithm inspired by the structure and function of biological neural networks. An NN includes hierarchical layers of interconnected groups of artificial neurons, where each layer of neurons receives as inputs the outputs of a lower layer.

Deep neural networks (DNNs) are a type of NN that includes one or more hidden layers of neurons. The use of DNNs for acoustic modeling in combination with Hidden Markov Models (HMMs) (statistical models in which the system being modeled is assumed to be a Markov process with unobserved states) in a hybrid recognition framework has resulted in improvements over the use of Gaussian Mixture Models (GMMs) and HMMs. DNNs provide various benefits such as the ability to model complex inputs with layers of nonlinearities, the sharing of parameters across output classes, and the simplicity of training methods. Given DNNs with sufficient structure in the form of the number of layers and units (e.g., inputs and/or neurons), the training algorithm is generally able to approximate arbitrary functions of inputs. The success with which this can be done depends, in part, on the topology of the network and the form of the activation function that is used. Despite these benefits over other machine learning approaches, conventional DNNs suffer from a number of drawbacks, technical solutions to which are described herein.

### SUMMARY

In one or more example embodiments of the disclosure, a method for training a classifier using a neural network is disclosed. The method includes determining, for a current iteration of the training, a set of inputs, a set of weight parameters corresponding to the set of inputs, bias parameters, and scale parameters. The method further includes determining, for the current iteration of the training, a set of combined inputs based at least in part on the set of inputs, the set of weight parameters, and the bias parameters. An activation function is then executed for the current iteration of the training with respect to each combined input in the set of combined inputs. Executing each activation function for the current iteration of the training includes applying the activation function to a particular combined input and a current scale parameter to generate an activation result. The method additionally includes determining whether the current iteration of the training is a final iteration of the training, and outputting, based at least in part on determining whether the current iteration of the training is a final iteration of the training, a set of activation results associated with the final iteration of the training as classifier outputs of the classifier or providing the activation results as input to a next iteration of the training.

In one or more other example embodiments of the disclosure, a system for training a classifier is disclosed. The system includes at least one memory storing computer-executable instructions and at least one processor configured to access the at least one memory and execute the computer-executable instructions to perform a set of operations. The operations include determining, for a current iteration of the training, a set of inputs, a set of weight parameters corresponding to the set of inputs, bias parameters, and scale parameters. The operations further include determining, for the current iteration of the training, a set of combined inputs based at least in part on the set of inputs, the set of weight parameters, and the bias parameters. An activation function is then executed for the current iteration of the training. Executing each activation function for the current iteration of the training includes applying the activation function to a particular combined input and a current scale parameter to generate an activation result. The operations additionally include determining whether the current iteration of the training is a final iteration of the training, and outputting, based at least in part on determining whether the current iteration of the training is a final iteration of the training, a set of activation results associated with the final iteration of the training as classifier outputs of the classifier or providing the set of activation results as input to a next iteration of the training.

In one or more other example embodiments of the disclosure, a computer program product for training a classifier is disclosed. The computer program product includes a non-transitory storage medium readable by a processing circuit, the storage medium storing instructions executable by the processing circuit to cause a method to be performed. The method includes determining, for a current iteration of the training, a set of inputs, a set of weight parameters corresponding to the set of inputs, bias parameters, and scale parameters. The method further includes determining, for the current iteration of the training, a combined input based at least in part on the set of inputs, the set of weight parameters, and the bias parameters. An activation function is then executed for the current iteration of the training with respect to each combined input in the set of combined inputs. Executing each activation function for the current iteration of the training includes applying the activation function to a particular combined input and a current scale parameter to generate an activation result. The method additionally includes determining whether the current iteration of the training is a final iteration of the training, and outputting, based at least in part on determining whether the current iteration of the training is a final iteration of the training, a set of activation results associated with the final iteration of the training as classifier outputs of the classifier or providing the set of activation results as input to a next iteration of the training.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 schematically depicts an illustrative operation of a classifier engine in accordance with one or more example embodiments of the disclosure.

FIG. 2 schematically depicts an illustrative classifier engine implemented as a deep neural network (DNN) in accordance with one or more example embodiments of the disclosure.

FIG. 3 is a process flow diagram of an illustrative method in accordance with one or more example embodiments of the disclosure.

FIG. 4 is a schematic diagram of an illustrative computer architecture in accordance with one or more example embodiments of the disclosure.

### DETAILED DESCRIPTION

### Overview

Disclosed herein are systems, methods, and computer-readable media for training a classifier (also referred to herein interchangeably as a classifier model). In one or more example embodiments, the classifier model may be a deep neural network (DNN) that includes an initial input layer, a final output layer, and one or more hidden layers. Each layer of the DNN may include one or more nodes, where each node may represent a neuron or an input parameter. Two or more layers of the DNN may contain a same number or a different number of nodes.

Each node in the initial input layer may represent a corresponding input parameter. For example, the initial input layer may include a set of nodes, each of which represents a training input in a set of inputs representative of a ground-truth dataset. The initial input layer may further include a node representing a bias parameter and a node representing an initial scale parameter.

The initial input layer may be followed in the DNN by a first hidden layer. The first hidden layer may include a respective set of neuron nodes, a node representing the bias parameter, and a node representing the scale parameter. Each node in the initial input layer may be connected to each neuron node in the first hidden layer by a respective corresponding connection that represents a weight to be applied to the input represented by the node in the initial input layer.

Each neuron node in the first hidden layer may be associated with a corresponding activation function. The activation function may be, for example, a non-linear squashing function such as a sigmoid function. Squashing functions output a value between 0 and 1 for any real-valued input. The activation function corresponding to each neuron node in the first hidden layer may receive as inputs the initial scale parameter from the initial input layer, the bias parameter, the set of training inputs, and a set of weights. More specifically, a linear combination may be determined by multiplying each training input in the set of training inputs by a respective corresponding weight in the set of weights, summing the quantities to obtain a first linear combination, and summing the bias parameter with the first linear combination to obtain a second linear combination. The activation function may be executed on the second linear combination and the initial scale parameter to generate an activation result. In this manner, a respective activation result may be determined for each neuron node in the first hidden layer. In certain example embodiments, a respective corresponding weight may be applied to each of the bias parameter and the initial scale parameter. For example, the bias parameter may be multiplied by a first weight prior to summing with the first linear combination, and the scale parameter may be multiplied by a second weight prior to execution of the activation function.

An activation result generated for any given neuron node in the first hidden layer may differ from the activation result generated for any other neuron node in the first hidden layer depending on the interconnection weights between the nodes in the initial input layer and the neuron nodes in the first hidden layer. For example, a first node in the initial input layer representative of a first training input may be connected to a first neuron node in the first hidden layer by a first weight, but may be connected to a second neuron node in the first hidden layer by a second different weight. Thus, the set of weights that is applied to the set of training inputs may differ from one neuron node in the first hidden layer to the next neuron node in the first hidden layer.

If the DNN includes additional hidden layer(s), the above-described process may be repeated with respect to each additional hidden layer. For example, if the DNN includes a second hidden layer, the respective activation result associated with each neuron node in the first hidden layer may be connected to each neuron node in the second hidden layer by a corresponding interconnection weight. In addition, a node representing the bias parameter in the first hidden layer as well as a node representing the scale parameter in the first hidden layer may be connected by respective corresponding interconnection weights to each neuron node in the second hidden layer.

Similar to the first hidden layer, each neuron node in the second hidden layer may be associated with a corresponding activation function. For each neuron node in the second hidden layer, the corresponding activation function may be executed on the scale parameter from the first hidden layer and a linear combination of: i) the set of activation results outputted by the first hidden layer, ii) the corresponding set of weights connecting the nodes from the first hidden layer to the neuron node in the second layer, and iii) the bias parameter from the first hidden layer to generate a set of activation results for the second hidden layer.

If subsequent hidden layer(s) are present in the DNN, each activation result generated by a neuron node in a given hidden layer may be provided as input to each neuron node in a subsequent hidden layer. In a manner similar to that described earlier, a subsequent set of activation results may then be generated at the subsequent hidden layer based at least in part on the set of activation results received from the previous hidden layer, the bias parameter received from the previous hidden layer, and the scale parameter received from the previous hidden layer.

The above-described feed forward process may continue until a final output layer of the DNN is reached, at which point, the set of activation results provided to the final output layer may be output by the DNN as a set of classifier outputs. Each such classifier output may be compared to an actual target output associated with a corresponding training input to determine an amount of deviation between the classifier output and the actual target output. Training the DNN may include using these deviations between classifier outputs and actual target outputs to determine the optimal set of weights in the DNN that minimizes a cost/error function representing the error between the set of classifier outputs and the actual target outputs associated with a set of training inputs.

Generally speaking, training a DNN may involve utilizing a training method in conjunction with an optimization method. For example, a DNN in accordance with one or more example embodiments of the disclosure may be trained using backpropagation in conjunction with gradient descent in order to determine an optimal set of interconnection weights between the nodes of the various layers of the DNN. Backpropagation is a learning algorithm by which an initial set of randomly assigned interconnection weights of the DNN are updated to obtain an optimal set of interconnection weights that minimizes a cost/error function representing a total error between a set of classifier outputs and a set of actual target outputs for a given set of training inputs. A cost/error function may be deemed to be minimized, for example, when the total error is at or below some threshold value.

The backpropagation algorithm using gradient descent may include two phases: a backward error propagation phase and a weight update phase. During the backward propagation phase, a respective delta may be determined for each node of the output layer and each node of each hidden layer of the DNN. Each respective delta may represent a difference between the actual output associated with a node and the target output of the DNN for the initial set of inputs. In certain example embodiments, a delta determined for a node may be the derivative of the error function with respect to the input activation for that node multiplied by the derivative of the activation function with respect to the net input for that node.

Then, during the weight update phase, the delta determined for a first node may be multiplied by the input activation result received from a second node connected by an interconnection weight with the first node to obtain a gradient associated with the interconnection weight. A ratio of the gradient may then be determined and subtracted from the interconnection weight connecting the first and second nodes to obtain a new weight between the nodes. The ratio of the gradient that is used may be representative of a learning rate of the DNN that indicates how quickly the DNN is trained. The above process may be repeated during the weight update phase for each pairing of nodes connected by a corresponding interconnection weight to obtain a set of updated interconnection weights between the various nodes of the output and hidden layers of the DNN.

After each round of the above-described backpropagation algorithm, an updated set of interconnection weights may be obtained. These new weights may then be used to determine a new set of classifier outputs through the feed forward process of the DNN. The backpropagation algorithm may then be executed to once again determine an updated set of interconnection weights. The feed forward and backpropagation processes may be iteratively performed until the cost-error function associated with the DNN is minimized (or at or below some threshold value), at which point, a set of interconnection weights that are presumed to be an optimal set of weights are obtained. It should be appreciated that the change to an interconnection weight connecting a first node forming part of a particular layer of the DNN and a second node forming part of a subsequent layer of the DNN depends on the error associated with the second node (which in turn depends on the respective error associated with each node forming part of each (if any) subsequent layer of the DNN) and the activation result associated with the first node. The first node may be an input layer node or a hidden layer node and the second node may be a hidden layer node or an output layer node.

In accordance with example embodiments of the disclosure, the interconnection weights connecting pairs of nodes of different layers may be continually updated via repeated execution of the backpropagation algorithm. The weights that are updated may include the weights connecting neuron nodes, the weights connecting the bias parameter to neuron nodes, and the weights connecting the scale parameter to neuron nodes. In contrast to conventional DNN learning techniques, example embodiments of the disclosure provide a novel activation function that provides the capability to learn the scale parameter in addition to the bias parameter for each neuron as well as the weights connecting neuron nodes. More specifically, conventional DNN learning techniques utilize a fixed scale parameter, whereas example embodiments of the disclosure provide an activation function that allows the scale parameter to be learned through iterative execution of the backpropagation algorithm. In this manner, example embodiments provide a DNN that generates a more accurate classifier output than conventional DNNs.

Example embodiments of the disclosure include or yield various technical features, technical effects, and/or improvements to technology. For instance, example embodiments of the disclosure provide the technical effect of improved classification accuracy for a neural network. This technical effect is achieved as a result of the technical feature of learning a scale parameter of an activation function by continually updating a weight applied to the scale parameter, in addition to weights applied to other inputs, at each layer of a neural network via multiple feed-forward and backpropagation passes through the neural network for an initial training set of data. By virtue of the improved classification accuracy that is obtained, less computational resources in the form of memory and/or processing time/capacity are required to achieve a desired classification accuracy as compared to conventional supervised learning methods. Thus, example embodiments of the disclosure improve the functioning of a computer with respect to the operation of neural networks. It should be appreciated that the above examples of technical features, technical effects, and improvements to the functioning of a computer and computer technology provided by example embodiments of the disclosure are merely illustrative and not exhaustive.

### Illustrative Embodiments

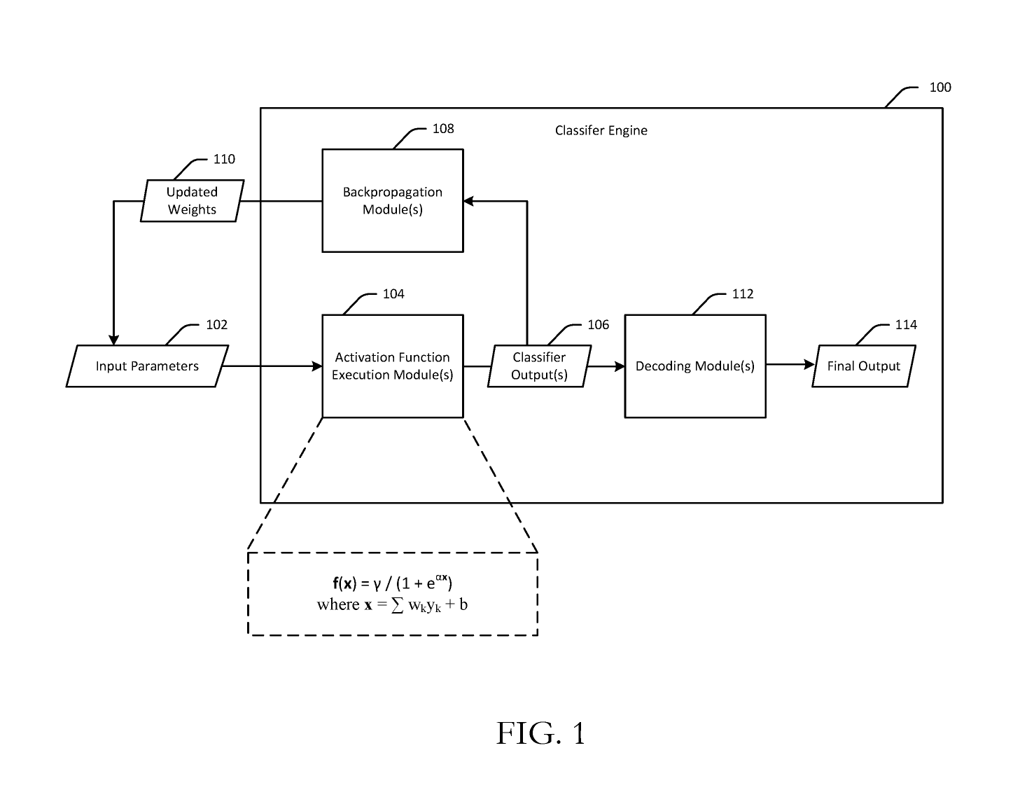

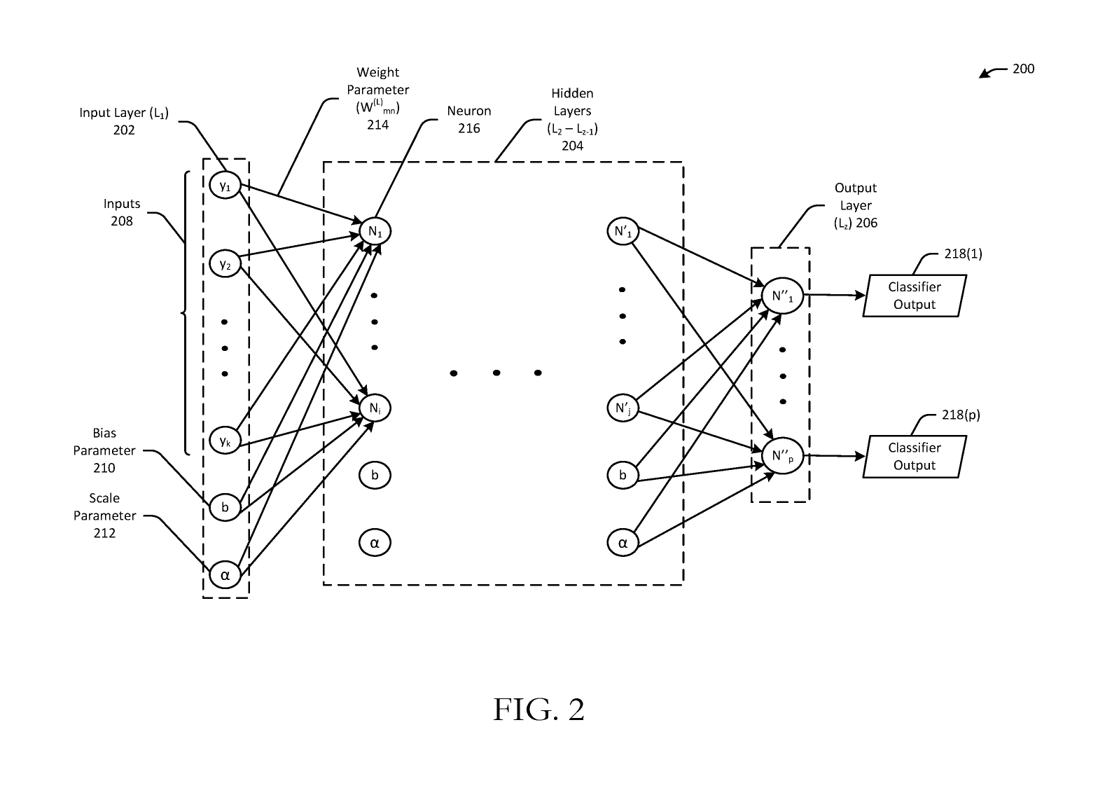

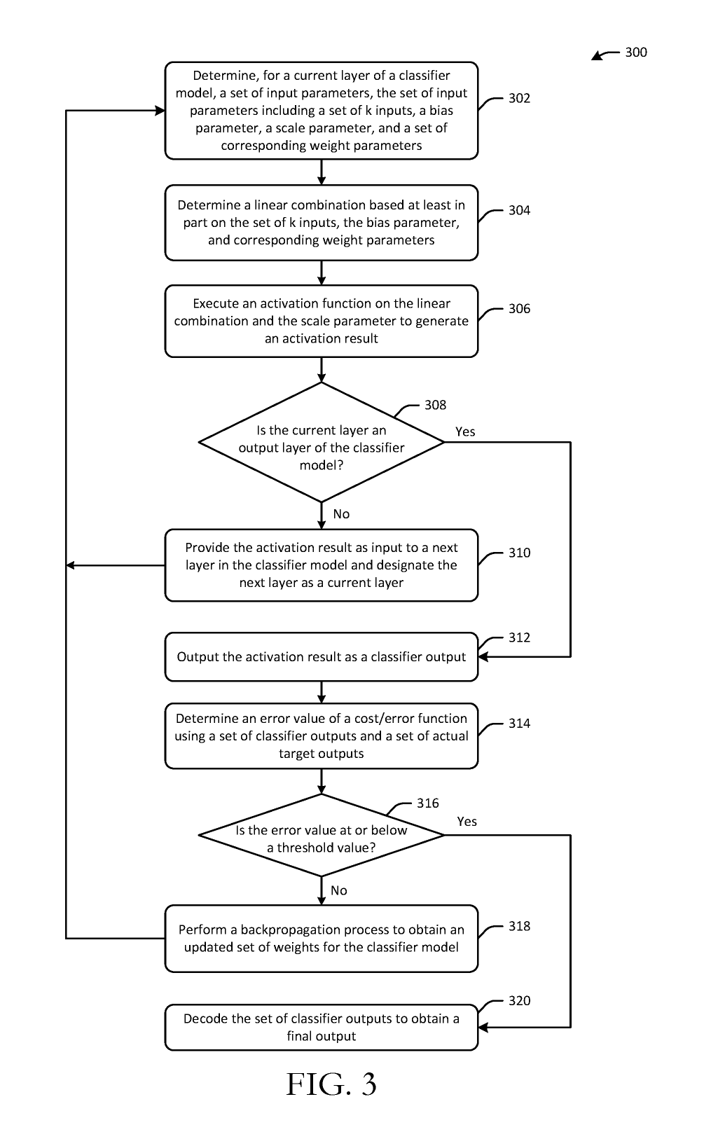

FIG. 1 schematically depicts an illustrative operation of a classifier engine in accordance with one or more example embodiments of the disclosure. FIG. 2 schematically depicts an illustrative deep neural network (DNN) in accordance with one or more example embodiments of the disclosure. FIG. 3 is a process flow diagram of an illustrative method 300 in accordance with one or more example embodiments of the disclosure. FIGS. 1-3 will be described in conjunction with one another hereinafter.

Referring first to FIG. 1, a classifier engine 100 is shown. The classifier engine 100 may be implemented on a computing device containing one or more processing units configured to execute computer-executable instructions, program code, or the like of the classifier engine 100 to cause one or more corresponding operations to be performed. In certain example embodiments, the classifier engine 100 may include one or more program modules such as, for example, one or more activation function execution modules 104, one or more backpropagation modules 108, and one or more decoding modules 112. Each such module or collection of modules may include computer-executable instructions, program code, or the like that responsive to execution by one or more processing circuits may cause a set of specialized tasks or operations to be performed. It should be appreciated that the classifier engine 100 may include any number of additional modules or sub-modules. Further, at times herein, the terms engine, module, or program module may be used interchangeably.

Referring now to FIGS. 1 and 3 in conjunction with one another, at block 302, computer-executable instructions of the activation function execution module(s) 104 may be executed to receive, or otherwise determine, a set of input parameters 102 for a current layer of a classifier model. While example embodiments of the disclosure may be described hereinafter using a DNN as an example classifier model, it should be appreciated that the techniques of the present disclosure are applicable to other types of classifier models as well such as, for example, other types of ANNs or supervised learning models.

The set of input parameters 102 may include a set of k inputs, a set of corresponding weights to be applied to the set of k inputs, a bias parameter, and a scale parameter. In certain example embodiments, the set of input parameters 102 may further include a respective weight to be applied to each of the bias parameter and the scale parameter. In an initial iteration of the method 300, the current layer of the classifier model may be a first hidden layer of the DNN. Assuming that the current layer is a first hidden layer of the DNN, the set of input parameters 102 may include a set of k initial inputs, an initial bias parameter, and an initial scale parameter, all of which may correspond to an initial input layer of the DNN. The set of input parameters 102 may further include a respective set of interconnection weights for each neuron node in the first hidden layer, where each respective set of interconnection weights may include a respective weight corresponding to each of the k inputs, the bias parameter, and the scale parameter.

At block 304, computer-executable instructions of the activation function execution module(s) 104 may be executed to determine a linear combination based at least in part on the set of k inputs, a respective set of weights corresponding to the k inputs, and the bias parameter. In certain example embodiments, the linear combination may be obtained by multiplying each of the k inputs by a respective corresponding weight, multiplying the bias parameter by a respective corresponding weight, and summing each of these quantities. It should be appreciated that a respective linear combination may be similarly determined with respect to each neuron node in the current layer of the classifier model.

At block 306, computer-executable instructions of the activation function execution module(s) 104 may be executed to execute an activation function on the linear combination obtained at block 304 and the scale parameter to generate an activation result. An example form of the activation function that may be executed at block 306 is shown in FIG. 1. The activation function may be a non-linear squashing function (e.g., a sigmoidal function) that receives the linear combination determined at block 304 and the scale parameter as inputs. While not depicted in FIG. 1, the bias parameter and the scale parameter may each have respective weights applied thereto that may be learned through iterative execution of the method 300. Thus, an activation function of the form shown in FIG. 1 allows for the scale parameter to be learned in addition to the bias parameter and the other interconnection weights. It should be appreciated that the activation function may be executed for each linear combination corresponding to a respective neuron node in the current layer in order to obtain a respective activation result for each neuron node of the current layer.

At block 308, computer-executable instructions of the activation function execution module(s) 104 may be executed to determine whether the current layer associated with a current iteration of the method 300 is an output layer of the classifier model (e.g., DNN). In response to a negative determination at block 308, computer-executable instructions of the activation function execution module(s) 104 may be executed at block 310 to provide each activation result obtained at block 306 as input to a next layer in the classifier model (e.g., DNN), and the next layer may be designated as a current layer for a next iteration of the method 300. More specifically, a respective activation result obtained at block 306 may be provided as input to each neuron node in the next hidden layer of the DNN along with a respective corresponding weight to be applied to the activation result for each neuron node in the next layer. The method 300 may then proceed iteratively from block 302, where a set of input parameters may be determined for the now current layer. The set of input parameters may include the respective activation result generated by each neuron node in the prior hidden layer; a bias parameter from the prior hidden layer; a scale parameter from the prior hidden layer; and a respective weight for each activation result, the bias parameter, and the scale parameter.

On the other hand, in response to a positive determination at block 308 (indicating that the current layer is an output layer), the method 300 may proceed to block 312, where the activation result associated with each neuron node in the output layer may become a classifier output for that neuron node. More specifically, referring again to FIGS. 1 and 3 in conjunction with one another, the total output at block 312 may be a set of classifier outputs 106 comprising the activation results associated with the neuron nodes of the output layer.

At block 314, the set of classifier outputs 106 may be provided as input to the backpropagation module(s) 108, and computer-executable instructions of the backpropagation module(s) 108 may be executed to determine an error value of a cost/error function. The error value may be determined using the set of classifier outputs 106 and a set of actual target outputs associated with the initial training set of inputs.

At block 316, computer-executable instructions of the backpropagation module(s) 108 may be executed to determine whether the error value is at or below a threshold value. Referring once again to FIGS. 1 and 3 in conjunction with one another, in response to a negative determination at block 316, the backpropagation process similar to that previously described may be performed, at block 318, to obtain an updated set of interconnection weights 110. The set of weights included in the set of input parameters 102 from a previous iterative cycle of the method 300 through each layer of the DNN may be replaced with the updated set of interconnection weights 110, and the method 300 may again proceed from block 302 to initiate a new iterative cycle of the method 300 (e.g., a new feed forward cycle through the DNN).

On the other hand, in response to a positive determination at block 316 (indicating that the cost/error function has been sufficiently minimized), the set of classifier outputs 106 may be provided as input to the decoding module(s) 112, and computer-executable instructions of the decoding module(s) 112 may be executed, at block 320, to decode the set of classifier outputs 106 to obtain a final output 114.

In certain example embodiments, the method 300 may be executed in connection with a classifier model for classifying speech. In such example embodiments, the set of classifier outputs 106 may include a set of phonemes, and the final output 114 may be, for example, a word or phrase that the decoding module(s) 112 determine the set of phonemes correspond to.

FIG. 2 depicts a classifier model implemented as an example DNN 200 in accordance with one or more example embodiments of the disclosure. The method 300 of FIG. 3 may be iteratively executed on a set of training inputs in connection with the DNN 200. The DNN 200 may include an initial input layer L₁ 202 that includes an initial set of inputs y₁-yₖ 208, an initial bias parameter 210, and an initial scale parameter 212. The DNN 200 may further include one or more hidden layers L₂-L_{z-1} as well as an output layer L_{z}. A first hidden layer L₂ may include a set of neuron nodes N₁-Nᵢ, a bias parameter node, and a scale parameter node.

In a first iteration of the method 300, as part of a first iterative cycle of the method 300, a linear combination may be determined with respect to each neuron node 216 in the first hidden layer L₂. For example, for a particular neuron node 216, each initial input y₁-yₖ of the set of initial inputs 208 and the initial bias parameter 210 may be multiplied by a respective corresponding interconnection weight 214 to obtain a linear combination for that neuron node 216. The linear combination as well as an input corresponding to a respective interconnection weight multiplied by the initial scale parameter 212 may be provided as inputs to the activation function (e.g., the example activation function depicted in FIG. 1), which may be executed to obtain a respective activation result corresponding to that particular neuron node 216. A similar technique may be employed to obtain a respective activation result for each other neuron node 216 in the first hidden layer L₂. Each of these activation results may then be provided as inputs to neuron nodes of a next layer in the DNN 200.

If an additional hidden layer L₃ is present in the DNN 200, additional iterations of the method 300 may be performed as part of the first iterative cycle to similarly obtain respective activation results for each neuron node in the hidden layer L₃. As long as further hidden layer(s) are present in the DNN 200, the activation results determined for a given hidden layer may be provided as inputs along with the bias parameter and the scale parameter to each neuron node of a subsequent hidden layer. These inputs may be weighted by corresponding interconnection weights and an activation function may be executed thereon to obtain a respective activation result for each neuron node in the subsequent hidden layer.

The first iterative cycle of the method 300 may continue in the above-described manner until a final output layer L_{z} 206 of the DNN 200 is reached. The set of activation results associated with the neuron nodes of the output layer L_{z} 206 may then be output as classifier outputs 218(1)-218(p). A total error may then be determined for the DNN 200 using the set of classifier outputs 218(1)-218(p) and a set of actual target outputs. If the total error is greater than a threshold value, or it is otherwise determined that a cost/error function is not minimized by the set of classifier outputs 218(1)-218(p), then a backpropagation process as described earlier may be performed to update the various interconnection weights of the DNN 200. A second subsequent iterative cycle of the method 300 may then be performed using the updated set of interconnection weights. This process may continue until a set of classifier outputs 218(1)-218(p) is obtained that minimizes the cost/error function.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure.

### Illustrative Computer Architecture

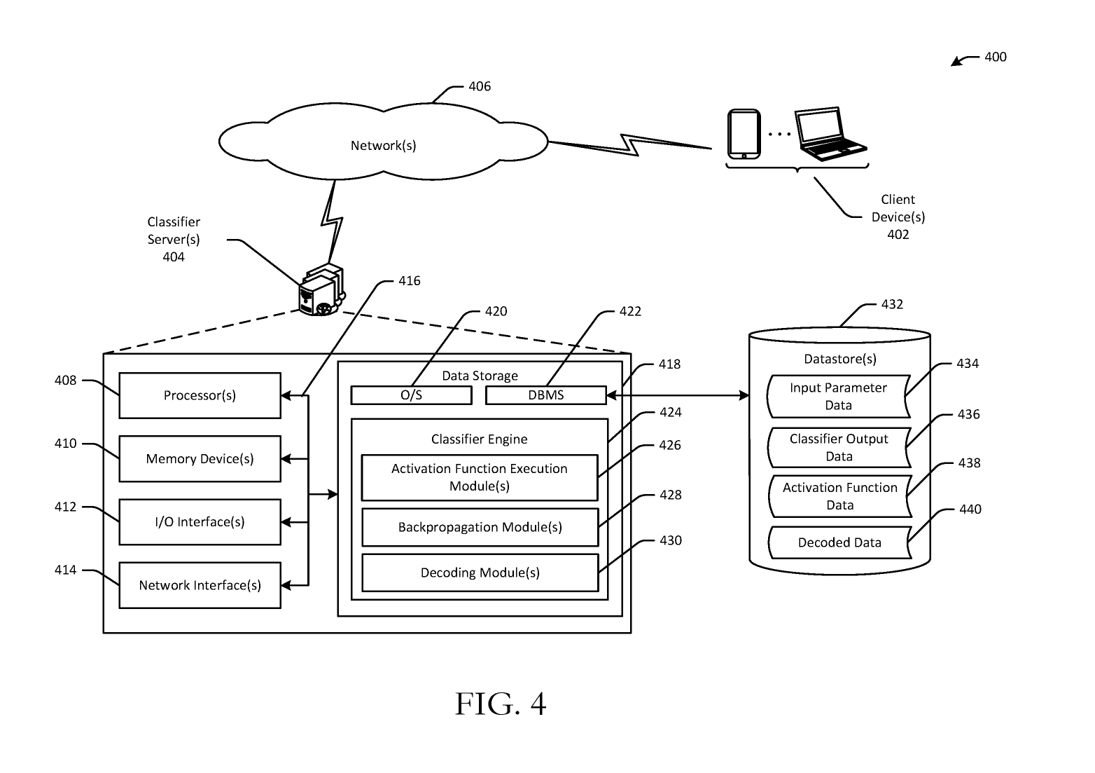

FIG. 4 is a schematic diagram of an illustrative computer architecture 400 in accordance with one or more example embodiments of the disclosure. The architecture 400 may include one or more client devices 402 and one or more classifier servers 404 configured to communicate over one or more networks 406. The client device(s) 402 may include any suitable device including, without limitation, a smartphone, a tablet device, a personal computer, or the like. In certain example embodiments, a client device 402 may provide a speech input function whereby speech is received as input by the client device 402 and transmitted to the classifier server(s) 404 for processing to obtain a speech-to-text output that is transmitted to the client device 402 for presentation via a user interface thereof. While the classifier server 404 may be described herein in the singular, it should be appreciated that multiple instances of the classifier server 404 may be provided, and functionality described in connection with the classifier server 404 may be distributed across such multiple instances.

In an illustrative configuration, the classifier server 404 may include one or more processors (processor(s)) 408, one or more memory devices 410 (generically referred to herein as memory 410), one or more input/output (“I/O”) interface(s) 412, one or more network interfaces 414, and data storage 418. The classifier server 404 may further include one or more buses 416 that functionally couple various components of the classifier server 404.

The bus(es) 416 may include at least one of a system bus, a memory bus, an address bus, or a message bus, and may permit the exchange of information (e.g., data (including computer-executable code), signaling, etc.) between various components of the classifier server 404. The bus(es) 416 may include, without limitation, a memory bus or a memory controller, a peripheral bus, an accelerated graphics port, and so forth. The bus(es) 416 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 410 of the classifier server 404 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 410 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 410 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 418 may include removable storage and/or non-removable storage including, but not limited to, magnetic storage, optical disk storage, and/or tape storage. The data storage 418 may provide non-volatile storage of computer-executable instructions and other data. The memory 410 and the data storage 418, removable and/or non-removable, are examples of computer-readable storage media (CRSM) as that term is used herein.

The data storage 418 may store computer-executable code, instructions, or the like that may be loadable into the memory 410 and executable by the processor(s) 408 to cause the processor(s) 408 to perform or initiate various operations. The data storage 418 may additionally store data that may be copied to memory 410 for use by the processor(s) 408 during the execution of the computer-executable instructions. Moreover, output data generated as a result of execution of the computer-executable instructions by the processor(s) 408 may be stored initially in memory 410, and may ultimately be copied to data storage 418 for non-volatile storage.

More specifically, the data storage 418 may store one or more operating systems (O/S) 420; one or more database management systems (DBMS) 422 configured to access the memory 410 and/or one or more datastores 432; and one or more program modules, applications, engines, computer-executable code, scripts, or the like such as, for example, a classifier engine 424. The classifier engine 424 may include one or more program modules configured to be executed to perform more specialized tasks such as, for example, one or more activation function execution modules 426, one or more backpropagation modules 428, and one or more decoding modules 430. Any of the components depicted as being stored in data storage 418 may include any combination of software, firmware, and/or hardware. The software and/or firmware may include computer-executable code, instructions, or the like that may be loaded into the memory 410 for execution by one or more of the processor(s) 408 to perform any of the operations described earlier in connection with correspondingly named engines or modules.

Although not depicted in FIG. 4, the data storage 418 may further store various types of data utilized by components of the classifier server 404 (e.g., any of the data depicted as being stored in the datastore(s) 432). Any data stored in the data storage 418 may be loaded into the memory 410 for use by the processor(s) 408 in executing computer-executable code. In addition, any data stored in the data storage 418 may potentially be stored in the datastore(s) 432 and may be accessed via the DBMS 422 and loaded in the memory 410 for use by the processor(s) 408 in executing computer-executable instructions, code, or the like.

The processor(s) 408 may be configured to access the memory 410 and execute computer-executable instructions loaded therein. For example, the processor(s) 408 may be configured to execute computer-executable instructions of the various program modules, applications, engines, or the like of the classifier server 404 to cause or facilitate various operations to be performed in accordance with one or more embodiments of the disclosure. The processor(s) 408 may include any suitable processing unit capable of accepting data as input, processing the input data in accordance with stored computer-executable instructions, and generating output data. The processor(s) 408 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 408 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 408 may be capable of supporting any of a variety of instruction sets.

Referring now to other illustrative components depicted as being stored in the data storage 418, the O/S 420 may be loaded from the data storage 418 into the memory 410 and may provide an interface between other application software executing on the classifier server 404 and hardware resources of the classifier server 404. More specifically, the O/S 420 may include a set of computer-executable instructions for managing hardware resources of the classifier server 404 and for providing common services to other application programs (e.g., managing memory allocation among various application programs). In certain example embodiments, the O/S 420 may control execution of one or more of the program modules depicted as being stored in the data storage 418. The O/S 420 may include any operating system now known or which may be developed in the future including, but not limited to, any server operating system, any mainframe operating system, or any other proprietary or non-proprietary operating system.

The DBMS 422 may be loaded into the memory 410 and may support functionality for accessing, retrieving, storing, and/or manipulating data stored in the memory 410, data stored in the data storage 418, and/or data stored in the datastore(s) 432. The DBMS 422 may use any of a variety of database models (e.g., relational model, object model, etc.) and may support any of a variety of query languages. The DBMS 422 may access data represented in one or more data schemas and stored in any suitable data repository.

The datastore(s) 432 may include, but are not limited to, databases (e.g., relational, object-oriented, etc.), file systems, flat files, distributed datastores in which data is stored on more than one node of a computer network, peer-to-peer network datastores, or the like. The datastore(s) 432 may store various types of data including, without limitation, input parameter data 434 (e.g., the set of input parameters 102, the updated weights 110, etc.); classifier output data (e.g., the set of classifier outputs 106); activation function data (e.g., the activation function depicted in FIG. 1, activation results associated with neuron nodes, etc.); and decoded data (e.g., the final output 114). It should be appreciated that in certain example embodiments, any of the datastore(s) 432 and/or any of the data depicted as residing thereon may additionally, or alternatively, be stored locally in the data storage 418.

Referring now to other illustrative components of the classifier server 404, the input/output (I/O) interface(s) 412 may facilitate the receipt of input information by the classifier server 404 from one or more I/O devices as well as the output of information from the classifier server 404 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the classifier server 404 or may be separate. The I/O devices may further include, for example, any number of peripheral devices such as data storage devices, printing devices, and so forth.

The I/O interface(s) 412 may also include an interface for an external peripheral device connection such as universal serial bus (USB), FireWire, Thunderbolt, Ethernet port or other connection protocol that may connect to one or more networks. The I/O interface(s) 412 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The classifier server 404 may further include one or more network interfaces 414 via which the classifier server 404 may communicate with any of a variety of other systems, platforms, networks, devices, and so forth. The network interface(s) 414 may enable communication, for example, with one or more other devices (e.g., a client device 402) via one or more of the network(s) 406 which may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. The network(s) 406 may have any suitable communication range associated therewith and may include, for example, global networks (e.g., the Internet), metropolitan area networks (MANs), wide area networks (WANs), local area networks (LANs), or personal area networks (PANs). In addition, the network(s) 406 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

It should be appreciated that the engines/modules depicted in FIG. 4 as being stored in the data storage 418 (or depicted in FIG. 1) are merely illustrative and not exhaustive and that processing described as being supported by any particular engine or module may alternatively be distributed across multiple engines, modules, or the like, or performed by a different engine, module, or the like. In addition, various program module(s), script(s), plug-in(s), Application Programming Interface(s) (API(s)), or any other suitable computer-executable code hosted locally on the classifier server 404 and/or hosted on other computing device(s) accessible via one or more of networks, may be provided to support functionality provided by the engines/modules depicted in FIGS. 1 and 4 and/or additional or alternate functionality. Further, functionality may be modularized differently such that processing described as being supported collectively by the collection of engines/modules depicted in FIGS. 1 and 4 may be performed by a fewer or greater number of engines or program modules, or functionality described as being supported by any particular engine or module may be supported, at least in part, by another engine or program module. In addition, engines or program modules that support the functionality described herein may form part of one or more applications executable across any number of devices of the classifier server 404 in accordance with any suitable computing model such as, for example, a client-server model, a peer-to-peer model, and so forth. In addition, any of the functionality described as being supported by any of the engines/modules depicted in FIGS. 1 and 4 may be implemented, at least partially, in hardware and/or firmware across any number of devices.

It should further be appreciated that the classifier server 404 may include alternate and/or additional hardware, software, or firmware components beyond those described or depicted without departing from the scope of the disclosure. More particularly, it should be appreciated that software, firmware, or hardware components depicted as forming part of the classifier server 404 are merely illustrative and that some components may not be present or additional components may be provided in various embodiments. While various illustrative engines/modules have been depicted and described as software engines or program modules stored in data storage 418, it should be appreciated that functionality described as being supported by the engines or modules may be enabled by any combination of hardware, software, and/or firmware. It should further be appreciated that each of the above-mentioned engines or modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular engine or module may, in various embodiments, be provided at least in part by one or more other engines or modules. Further, one or more depicted engines or modules may not be present in certain embodiments, while in other embodiments, additional engines or modules not depicted may be present and may support at least a portion of the described functionality and/or additional functionality. Moreover, while certain engines modules may be depicted or described as sub-engines or sub-modules of another engine or module, in certain embodiments, such engines or modules may be provided as independent engines or modules or as sub-engines or sub-modules of other engines or modules.

One or more operations of the methods 200 or 300 may be performed by one or more classifier servers 404 having the illustrative configuration depicted in FIG. 4, or more specifically, by one or more engines, program modules, applications, or the like executable on such classifier server(s) 404. It should be appreciated, however, that such operations may be implemented in connection with numerous other system configurations.

The operations described and depicted in the illustrative method of FIG. 3 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIG. 3 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular system, system component, device, or device component may be performed by any other system, device, or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for training a neural network (NN) comprising a plurality of layers including at least one hidden layer, wherein each of the plurality of layers includes a respective set of nodes, the method comprising:
determining, for a current layer of the NN for a current iteration of the training, i) a set of inputs, the set of inputs including a set of training inputs or a set of activation results associated with the respective set of nodes of a prior layer of the NN, ii) a bias parameter, iii) a scale parameter, and iv) a respective set of weights to be applied to the set of inputs, the bias parameter, and the scale parameter for each node of the current layer of the NN;
determining, for a particular node of the current layer during the current iteration of the training, a combined input based at least in part on the set of inputs, the respective set of weights associated with the particular node, and the bias parameter;
weighting the scale parameter using a corresponding weight in the respective set of weights to obtain a weighted scale parameter, wherein the corresponding weight is learned from one or more prior iterations of the training;
executing, for the current iteration of the training, an activation function for the particular node, wherein executing the activation function comprises applying the activation function to the combined input and the weighted scale parameter to generate an activation result for the particular node;
determining whether the current layer is a final layer; and
outputting, based at least in part on determining whether the current layer is a final layer, the activation result as a classifier output of the NN or providing the activation result as input to a next layer of the NN.

2. The computer-implemented method of claim 1, wherein it is determined that the current layer is the final layer, and wherein the activation result is output as the classifier output of the NN.

3. The computer-implemented method of claim 2, further comprising:
determining a difference between an actual target output and the classifier output; and
updating the respective set of weights to be applied during a next iteration of the training based at least in part on the difference between the actual target output and the classifier output.

4. The computer-implemented method of claim 3, further comprising:
determining a cumulative error associated with all nodes in the NN;
determining that the cumulative error exceeds a threshold value; and
determining that the next iteration of the training should be performed in response to determining that the cumulative error exceeds the threshold value.

5. The computer-implemented method of claim 4, wherein the updating is performed in response to determining that the next iteration of the training should be performed.

6. The computer-implemented method of claim 2, further comprising:
determining the set of inputs from an acoustic signal; and
decoding a set of classifier outputs including the classifier output to determine a character string corresponding to the acoustic signal.

7. The computer-implemented method of claim 1, further comprising:
determining that a threshold number of iterations of the training have been performed, wherein a respective final set of weights to be applied when executing the activation function for each node in the NN is obtained after performing a final iteration of the training.

8. A system for training a neural network (NN) comprising a plurality of layers including at least one hidden layer, wherein each of the plurality of layers includes a respective set of noes, the system comprising:
at least one memory storing computer-executable instructions; and
at least one processor configured to access the at least one memory and execute the computer-executable instructions to:
determine, for a current layer of the NN for a current iteration of the training, i) a set of inputs, the set of inputs including a set of training inputs or a set of activation results associated with the respective set of nodes of a prior layer of the NN, ii) a bias parameter, iii) a scale parameter, and iv) a respective set of weights to be applied to the set of inputs, the bias parameter, and the scale parameter for each node of the current layer of the NN;
determine, for a particular node of the current layer during the current iteration of the training, a combined input based at least in part on the set of inputs, the respective set of weights associated with the particular node, and the bias parameter;
weight the scale parameter using a corresponding weight in the respective set of weights to obtain a weighted scale parameter, wherein the corresponding weight is learned from one or more prior iterations of the training;
execute, for the current iteration of the training, an activation function, wherein executing the activation function comprises applying the activation function to the combined input and the weighted scale parameter to generate an activation result for the particular node;
determine whether the current layer is a final layer; and
output, based at least in part on determining whether the current layer is a final layer, the activation result as a classifier output of the NN or providing the activation result as input to a next layer of the NN.

9. The system of claim 8, wherein it is determined that the current layer is the final layer, and wherein the activation result is output as the classifier output of the NN.

10. The system of claim 9, wherein the at least one processor is further configured to execute the compute-executable instructions to:
determine a difference between an actual target output and the classifier output; and
update the respective set of weights to be applied during a next iteration of the training based at least in part on the difference between the actual target output and the classifier output.

11. The system of claim 10, wherein the at least one processor is further configured to execute the compute-executable instructions to:
determine a cumulative error associated with all nodes in the NN;
determine that the cumulative error exceeds a threshold value; and
determine that the next iteration of the training should be performed in response to determining that the cumulative error exceeds the threshold value.

12. The system of claim 11, wherein the updating is performed in response to determining that the next iteration of the training should be performed.

13. The system of claim 9, wherein the at least one processor is further configured to execute the computer-executable instructions to:
determine the set of inputs from an acoustic signal; and
decode a set of classifier outputs including the classifier output to determine a character string corresponding to the acoustic signal.

14. The system of claim 8, wherein the at least one processor is further configured to execute the compute-executable instructions to:
determine that a threshold number of iterations of the training have been performed, wherein a respective final set of weights to be applied when executing the activation function for each node in the NN is obtained after performing a final iteration of the training.

15. A computer program product for training a neural network (NN) comprising a plurality of layers including at least one hidden layer, wherein each of the plurality of layers includes a respective set of nodes, the computer program product comprising a non-transitory storage medium readable by a processing circuit, the storage medium storing instructions executable by the processing circuit to cause a method to be performed, the method comprising:
determining, for a current layer of the NN for a current iteration of the training, i) a set of inputs, the set of inputs including a set of training inputs or a set of activation results associated with the respective set of nodes of a prior layer of the NN, ii) a bias parameter, iii) a scale parameter, and iv) a respective set of weights to be applied to the set of inputs, the bias parameter, and the scale parameter for each node of the current layer of the NN;
determining, for a particular node of the current layer during the current iteration of the training, a combined input based at least in part on the set of inputs, the respective set of weights associated with the particular node, and the bias parameter;
weighting the scale parameter using a corresponding weight in the respective set of weights to obtain a weighted scale parameter, wherein the corresponding weight is learned from one or more prior iterations of the training;
executing, for the current iteration of the training, an activation function for the particular node, wherein executing the activation function comprises applying the activation function to the combined input and the weighted scale parameter to generate an activation result for the particular node;
determining whether the current layer is a final layer; and
outputting, based at least in part on determining whether the current layer is a final layer, the activation result as a classifier output of the NN or providing the activation result as input to a next layer of the NN.

16. The computer program product of claim 15, wherein it is determined that the current layer is the final layer, and wherein the activation result is output as the classifier output of the NN.

17. The computer program product of claim 16, the method further comprising:
determining a difference between an actual target output and the classifier output; and
updating the respective set of weights to be applied during a next iteration of the training based at least in part on the difference between the actual target output and the classifier output.

18. The computer program product of claim 17, the method further comprising:
determining a cumulative error associated with all nodes in the NN;
determining that the cumulative error exceeds a threshold value; and
determining that the next iteration of the training should be performed in response to determining that the cumulative error exceeds the threshold value.

19. The computer program product of claim 18, wherein the updating is performed in response to determining that the next iteration of the training should be performed.

20. The computer program product of claim 16, the method further comprising:
determining the set of inputs from an acoustic signal; and
decoding a set of classifier outputs including the classifier output to determine a character string corresponding to the acoustic signal.
